(19) United States
(12) Patent Application Publication
(10) Pub. No.: US 2012/0152215 A1
(43) Pub. Date: Jun. 21, 2012

(54) DUAL FUEL SOURCE TRAILER TRACTOR

(76) Inventors: David Mazaika, Irvine, CA (US); Leavitt Mark, Irvine, CA (US); Sirosh Neel, Irvine, CA (US)

(21) Appl. No.: 13/311,350

(22) Filed: Dec. 5, 2011

Related U.S. Application Data
(60) Provisional application No. 61/459,564, filed on Dec. 15, 2010.

(51) Int. Cl. F02B 13/00; B23P 6/00

(52) U.S. Cl. 123/575; 29/888.011

(57) ABSTRACT

The present disclosure teaches a method to extend the distance interval between refueling for gaseous fueled tractor trailers. Recognizing the current dearth of a national gaseous refueling infrastructure to support long distance gaseous powered vehicle transport this disclosure provides a method and system of storing gaseous fuel in high pressure vessels on a tractor and on a trailer and operating an engine for the tractor (and trailer combination) with gaseous fuel feed from both tractor and trailer gaseous fuel supplies.

### RELATED APPLICATIONS

This application claims the full Paris Convention benefit of and priority to U.S. Provisional Patent Application Ser. No. 61/459,564, filed Dec. 15, 2010, the contents of which are incorporated by reference herein in its entirety, as if fully set forth herein.

### BACKGROUND

1. Field

This disclosure relates to devices and systems for extending the range of gaseous fuel powered vehicles. More particularly, the range of tractor trailers.

2. Summary

Today, gaseous fuels such as compressed natural gas (CNG), propane (LPG) or hydrogen are only in limited use on heavy duty trucks primarily because of the lower energy density of such fuels compared to gasoline or diesel which equates to a limited range between refueling. Coupled with gaseous fuel infrastructure (refueling stations) being sparsely distributed across the US it creates barriers to utilizing gaseous fuels as an alternative to gasoline or diesel.

According to aspects of at least: one exemplary implementation, a method to extend the distance interval between refueling for gaseous fueled tractor trailers. Recognizing the suboptimal gaseous refueling infra-structure currently in existence in the United States to support long distance vehicle transport this method comprises storing gaseous fuel in high pressure vessels on a tractor and on a trailer and operating an engine for the tractor (and trailer combination) with gaseous fuel feed from fuel lines from those vessels.

According to aspects of at least one exemplary implementation fuel exiting gaseous storage vessels into fuel lines is reduced in pressure.

According to aspects of at least one exemplary implementation the tractor side vessels and the trailer side vessels may be decoupled.

According to aspects of at least one exemplary implementation the gaseous storage vessels on each of the tractor side and the trailer side have separate refill receptacles.

According to aspects of at least one exemplary implementation at least one check valves is in the fuel line of the tractor side fuel line supplying gaseous fuel to the engine to inhibit the back flow of gaseous fuel to the trailer side fuel lines.

According to aspects of at least one exemplary implementation a dual fuel system for a tractor trailer a tractor and a trailer each has high pressure gaseous storage vessels; a tractor engine configured to operate on gaseous fuel supplied by fuel liens from the tractor side storage vessels and the trailer side storage vessels. In some instance a couple/decouple connector device between said trailer side fuel line and said tractor side fuel line is preferred. In some instance the dual fuel system includes a pressure reducer integral in each vessel.

According to aspects of at least one exemplary implementation a dual fuel system for a tractor trailer a tractor and a trailer each has high pressure gaseous storage vessels; a tractor engine configured to operate on gaseous fuel supplied by fuel liens from the tractor side storage vessels and the trailer side storage vessels. In some instance a couple/decouple connector device between said trailer side fuel line and said tractor side fuel line is preferred. In some instance the dual fuel system includes a refill receptacle on the fuel line for the tractor side vessels; and, a refill receptacle for the fuel line for the trailer side vessels.

According to aspects of at least one exemplary implementation a method to expand an on board fuel supply, is disclosed of affixing a tractor with an internal combustion engine that which operates on gaseous fuel supplied from gaseous fuel in pressure vessels on a removable trailer; and, reversibly coupling said fuel lines from said the gaseous fuel supply to the engine. In some instances, the method further comprising supplying gaseous fuel via fuel lines for said engine from gaseous fuel supplied from pressure vessels on both the tractor and on said trailer.

According to aspects of at least one exemplary implementation a method to reduce delays in transport, is disclosed the method comprising: affixing a tractor with an internal combustion engine that which operates on gaseous fuel to a trailer; preloading pressure vessels on said trailer with gaseous fuel before connecting said trailer to said tractor; and, reversibly coupling fuel lines from the trailer's pressurized vessels to the engine.

### DRAWINGS

The above-mentioned features and objects of the present disclosure will become more apparent with reference to the following description taken in conjunction with the accompanying drawings wherein like reference numerals denote like elements and in which:

FIG. 1 shows a top view of a dual gaseous fuel arrangement on a tractor and trailer.

FIG. 2 is a schematic of a dual fuel system of pressure fuel tanks.

FIG. 3 shows a side view of a tractor and trailer with a gaseous dual fuel system

FIG. 4 shows a perspective view of a tractor and trailer with a gaseous dual fuel system.

FIG. 5 shows an exploded view of FIG. 4 at circle A.

FIG. 6 shows an exploded view of FIG. 4 at circle B.

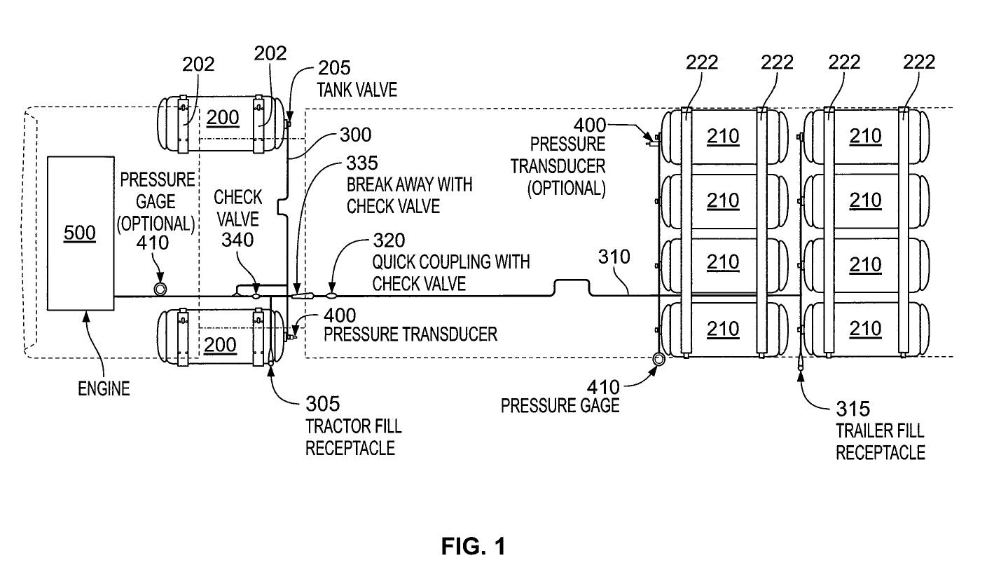

Appendices A and B are exploded pressure line views of FIG. 1.

All descriptions and callouts in the Figures and Appendices are hereby incorporated by this reference as if fully set forth herein.

### FURTHER DESCRIPTION

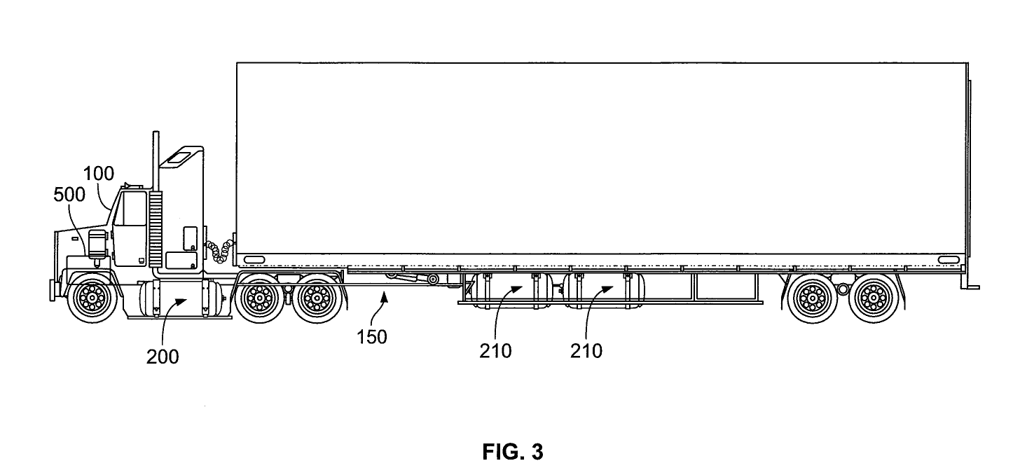

According to aspects of at least one exemplary implementation, a gaseous fuel system for tractor/trailer combination vehicles is disclosed. FIG. 3 shows a tractor 100 and trailer 150 combination wherein one or more tractor pressurized gaseous fuel storage vessels 200 are mounted on said tractor. Said vessels should have a pressure in excess of about 300 psi. Mounted on said trailer are one or more trailer pressurized gaseous fuel storage vessels 210 also with a pressure in excess of 300 psi. The tractor and trailer are separate modules. That is, said tractor may transport a variety of trailers and said trailers may be transported by a variety of tractors.

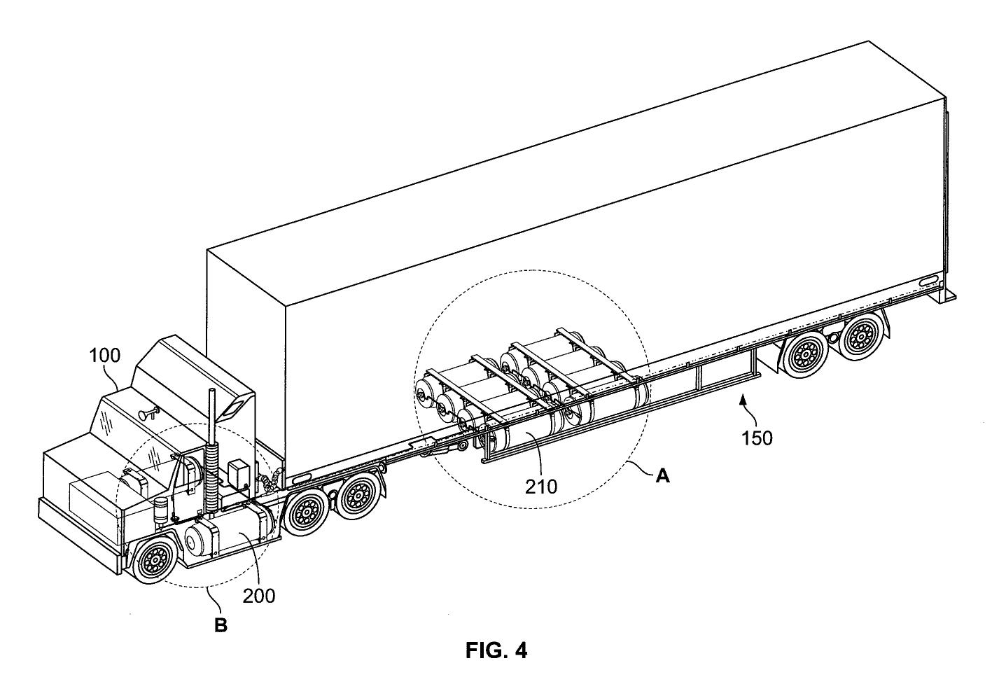

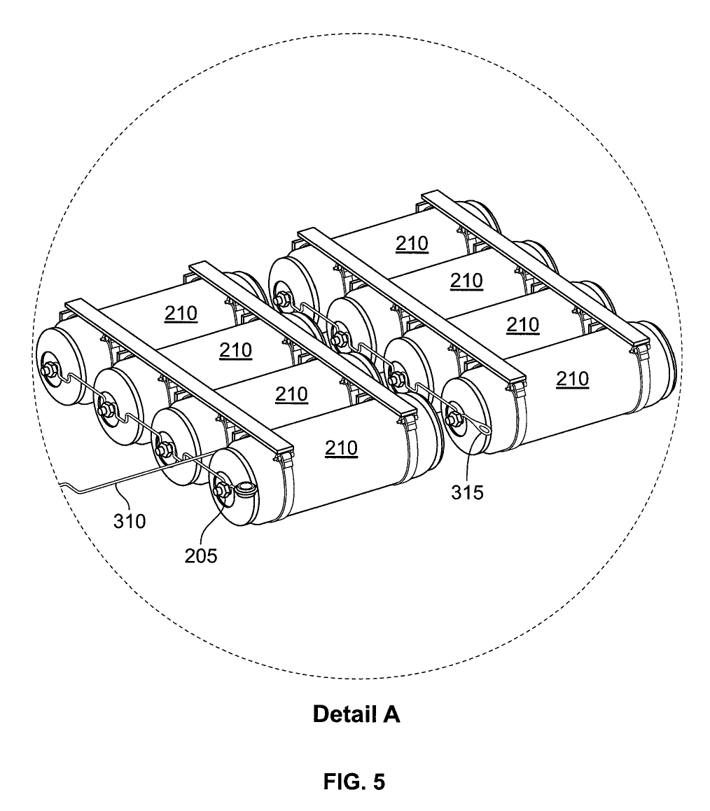

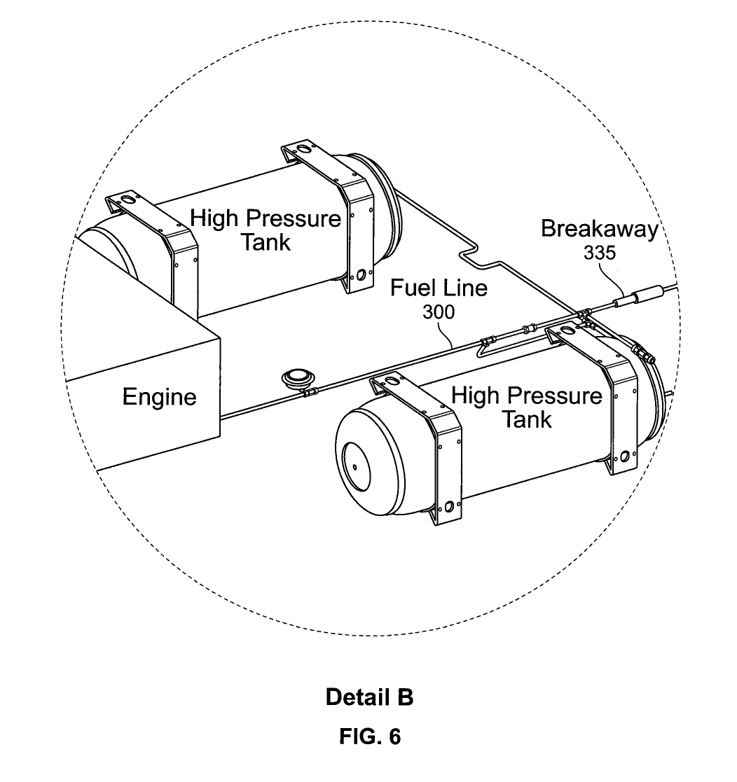

As shown in FIGS. 1 through 6 and appendices A & B said tractor 100 with tractor pressurized gaseous fuel storage vessels 200 supply gaseous fuel to tractor engine 500 which operates on a pressurized gaseous fuel feed. Said tractor pressurized gaseous fuel storage vessels 200 may be affixed to said tractor with tank mounts 202 suspending them on said tractor. In some implementations multiple tractor pressurized gaseous fuel storage vessels 200 are fluidly connected via pressure fuel line 300. The gaseous fuel from pressure fuel line 300 feeds into engine fuel line 510 to supply said engine 500 with fuel. The tractor pressurized gaseous fuel storage vessels 200 have a fill receptacle 305 to recharge the gaseous fuel into the vessels. Each of said vessels also has a tank valve 205 to control inflow during recharging of fuel and outflow during fuel use. Preferably the tank valves 205 contains or is used in combination with a pressure reduction device such as a pressure regulator wherein the high pressure gaseous fuel in the vessels is released into the fuel lines at lowered pressure. It is preferred that excess flow valves be integrated into each tank to minimize any release should a line become impaired.

As shown in FIGS. 1 through 6 and appendices A & B said trailer 150 contains trailer pressurized gaseous fuel storage vessels 210 to also supply gaseous fuel to tractor engine 500. Said trailer pressurized gaseous fuel storage vessels 210 are affixed to said trailer with trailer tank mounts 222 suspending them on said trailer. Although not shown those of ordinary skill in the art will recognize that the tank mounts and vessels are a frame of movable vessels and such vessels on tank mounts may be removed from one trailer and placed on another to make the trailer pressurized gaseous fuel storage vessels 210 modular between similar trailers. In some implementations multiple trailer pressurized gaseous fuel storage vessels 210 are fluidly connected via pressure fuel line 310. The gaseous fuel from pressurized fuel line 310 feeds into engine pressurized fuel line 510 to supply said engine 500 with fuel. Fuel line 310 connects with fuel line 300 which is on the tractor side of the dual pressurized fuel system. The trailer pressurized gaseous fuel storage vessels 210 have a fill receptacle 315 to recharges the gaseous fuel into the vessels. Each of said vessels also has a tank valve 205 to control inflow during recharging of fuel and outflow during fuel use.

Said gaseous fuel storage vessels 210 may be preloaded while on a trailer but prior to said trailer being attached to a tractor. Preloading said vessels is advantageous to reduce delay time due to fuel filling when said tractor is connected to said trailer.

In some instances said tractor may have no fuel supply vessels and obtain its fuel from trailer pressurized gaseous fuel storage vessels 210.

While it is preferred that fuel lines 300 and 310 are low pressure which supports the use of traditional flexible low pressure connecting line between the tractor and trailer similar to air lines for braking which are traditionally used between the tractor and trailer, it is also within the scope of this disclosure to utilize high pressure fuel lines as appropriate.

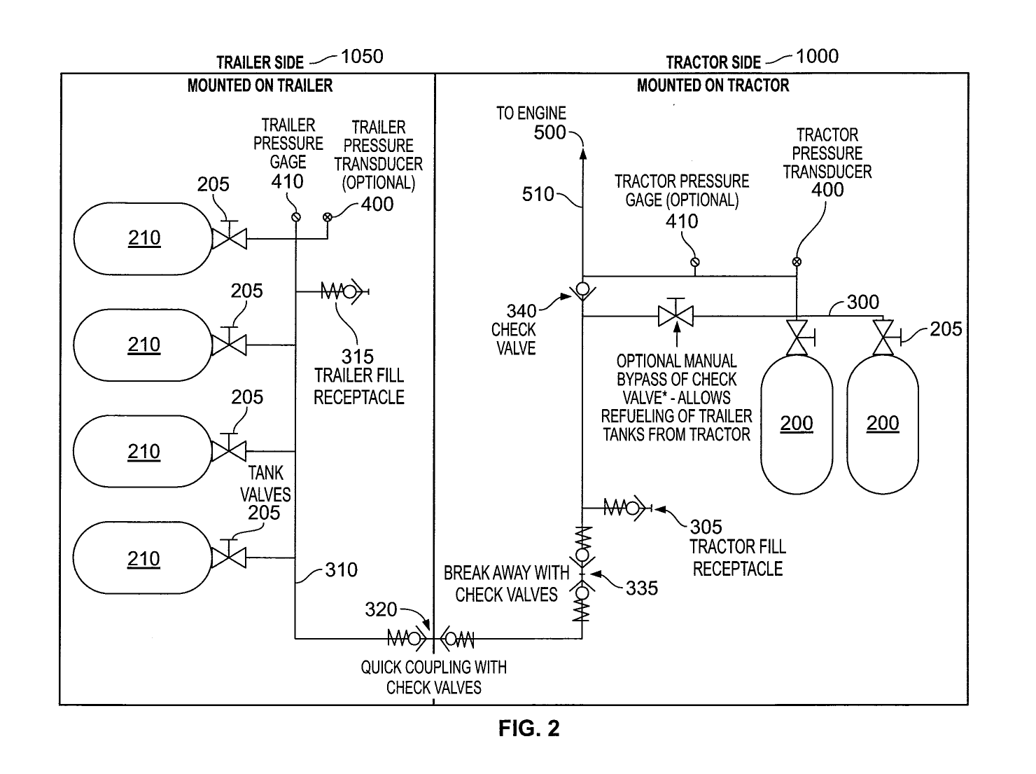

As detailed in FIGS. 1 and 2 the tractor side gaseous fuel storage 1000 and the trailer side gaseous fuel storage 1050 can be fluidly connected whereby engine 500 is supplied a gaseous fuel from the combined fuel storage vessels in both of said tractor side and said trailer side. The trailer side gaseous fuel storage 1050 connects via coupling a with check valves between fuel line 310 and fuel line 300. Said coupling also is used to decouple said fuel lines. An additional break away check valve 335 is placed in the fuel lines to provide a point of separation should and accident or the like cause the tractor and trailer to disassociate without normal decoupling of the fuel lines from the trailer side gaseous fuel storage and the tractor side gaseous fuel storage. To ensure the tractor side pressurized gaseous fuel storage vessels 200 do not back fill the trailer side pressurized gaseous fuel storage vessels 210 if filling the tractor side pressurized gaseous fuel storage vessels 200 when the trailer fuel line 310 and tractor fuel line 300 are coupled an additional check valve 340 is placed in the fuel line.

A method of providing a trailer having integrated gaseous fuel tanks is also disclosed whereby said trail is preloaded with fuel at the point of connection to said tractor. Moreover, in some instance said trailer fuel vessels, as shown in FIG. 3, may be fitted on a carriage under said trailer the carriage being modular and providing the option of swapping out said fuel vessels with charged, or filled vessels.

Pressure gauges to monitor the line pressure in any of he fuel lines 300, 310 and 500 may be added. Pressure transducers/sensors and gauges (400, 410) may be added to monitor and sense pressure and pressure changes within the pressure lines and/or open/close valves.

In other implementations a high pressure fill line (not shown) may be added with appropriate check valves to support high pressure fill of one or both of the tractor side fuel storage 1000 and the trailer side fuel storage 1050. A high pressure line used to connect the tractor/trailer fuel systems supports filling through a single port. If running a high pressure line between the tractor and trailer design considerations should include materials for the lines appropriate to withstand bending and twisting associated with the truck being driven.

According to aspects of at least one exemplary implementation, adequate control systems and devices may be provided in connection with relevant components to monitor the system, control operation thereof, and interface with a user or other systems. Such control systems may store, process, and communicate operation parameters, commands, data, and information relating to the system.

According to aspects of at least one exemplary implementation, any given device or component of the present disclosure m ay be provided in plurality through the system. For example, multiple valves, etc. may be provided in series or parallel to provide customizable results. By further example, multiple storage tanks 30 may be provided and connected to a common line leading to a destination.

Aspects of exemplary implementations disclosed herein are intended to be capable of combination, separation, and exchange with other aspects of exemplary implementations disclosed herein, except where expressly stated otherwise.

While the method and agent have been described in terms of what are presently considered to be the most practical a id preferred exemplary implementations, it is to be understood that the disclosure need not be limited to the disclosed exemplary implementations. It is intended to cover various modifications and similar arrangements included within the spirit and scope of the claims, the scope of which should be accorded the broadest interpretation so as to encompass all such modifications and similar structures. The present disclosure includes any and all exemplary implementations of the following claims.

It should also be understood that a variety of changes may be made without departing from the essence of the invention. Such changes are also implicitly included in the description. They still fall within the scope of this invention. It should be understood that this disclosure is intended to yield a pate it covering numerous aspects of the invention both independently and as an overall system and in both method and apparatus modes.

Further, each of the various elements of the invention and claims may also be achieved in a variety of manners. This disclosure should be understood to encompass each such variation, be it a variation of an exemplary implementation of any apparatus exemplary implementation, a method or process exemplary implementation, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular exemplary implementation, and to the extent otherwise applicable, the applicant should not be understood to have in any way intended to or actually relinquished such coverage as the applicant simply may not have been able to anticipate all eventualities; one skilled in the art, should not be reasonably expected 10 have drafted a claim that would have literally encompassed such alternative exemplary implementations.

Further, the use of the transition al phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A method to extend the distance interval between refueling for gaseous fueled tractor trailers, the method comprising:
storing gaseous fuel in high pressure vessels on a tractor;
storing gaseous fuel in high pressure vessels on a trailer;
operating an engine for a tractor with gaseous fuel; and,
supplying gaseous fuel for said engine from said tractor and said trailer vessels via fuel lines.

2. The method of claim 1 wherein gaseous fuel exiting said vessels into fuel lines is reduced in pressure.

3. The method of claim 1 wherein the tractor side vessels and the trailer side vessels may be decoupled.

4. The method of claim 1, the method further comprising:
a refill receptacle on the fuel line for the tractor side vessels; and,
a refill receptacle for the fuel line for the trailer side vessels.

5. The method of claim 1 wherein the fuel line from the tractor side vessels has one or more check valves to inhibit the back flow of gaseous fuel to the trailer side fuel lines.

6. A dual fuel system comprising:
a tractor with high pressure gaseous storage vessels
a trailer with high pressure gaseous storage vessels
a tractor engine configured to operate on gaseous fuel;
a tractor side fuel line fluidly connected to said storage vessels on said tractor; and,
a trailer side fuel line fluidly connected to said storage vessels on said trailer.

7. The dual fuel system of claim 6 further comprising a couple/decouple connection between said trailer side fuel line and said tractor side fuel line.

8. The dual fuel system of claim 6 wherein a pressure reducer is integral with each vessel.

9. The dual fuel system of claim 6, further comprising:
a refill receptacle on the fuel line for the tractor side vessels; and,
a refill receptacle for the fuel line for the trailer side vessels.

10. A method to expand an on board fuel supply, the method comprising:
affixing a tractor with an internal combustion engine that which operates on gaseous fuel supplied from gaseous fuel in pressure vessels on a removable trailer; and,
reversibly coupling said fuel lines from said the gaseous fuel supply to the engine.

11. The method of claim 10, the method further comprising supplying gaseous fuel via fuel lines for said engine from gaseous fuel supplied from pressure vessels on both the tractor and on said trailer.

12. A method to reduce delays in transport, the method comprising:
affixing a tractor with an internal combustion engine that which operates on gaseous fuel to a trailer;
preloading pressure vessels on said trailer with gaseous fuel before connecting said trailer to said tractor; and,
reversibly coupling fuel lines from the trailer's pressurized vessels to the engine.
